(19) United States
(12) Patent Application Publication
(10) Pub. No.: US 2005/0129879 A1
(43) Pub. Date: Jun. 16, 2005

(54) Base printed with ink receptive medium

(75) Inventor: John Bodis, Akron, OH (US)

Correspondence Address: HAHN LOESER & PARKS, LLP, One GOJO Plaza, Suite 300, AKRON, OH, 44311-1076, US

(73) Assignee: Forest Corporation

(21) Appl. No.: 10/735,464

(22) Filed: Dec. 12, 2003

(51) Int. Cl. B41M 5/00

(52) U.S. Cl. 428/32.24

(57) ABSTRACT

An ink receptive medium is disclosed. An ink receptive medium in accordance with the present invention comprises an ink receptive layer that is applied on a predetermined area of a non-porous image layer that has been printed on a substrate. The ink receptive layer of the present invention is receptive to an inkjet ink. Ink receptive medium made with this invention has utility for customized commercial printed advertising media that includes banners, displays, poster, signs, and the like.

### TECHNICAL FIELD

The present invention relates to a product having a portion thereof provided with an ink receptive medium. More particularly, the present invention relates to an inkjet receptive layer selectively provided on a predetermined area of a non-porous image layer overlaying the surface of a substrate, for use in custom printing of information or graphics in the predetermined area for such things as advertising media.

### BACKGROUND OF THE INVENTION

It is a well-known and widespread practice to seek increased retail sales by offering consumers various “specials” on selected items and goods. Typically, such specials offer the consumer a price reduction on specific items or goods when a specified quantity is purchased during the period the special is in effect. Because the reasons for offering a special are linked to variables, such as the need to relieve overstocked inventory, the need to meet competition, the need to deplete stocks of closed-out items or the like, the decision to offer a special is often made on short notice. Further, the exact terms of such specials may not be decided until just before the special is offered. Accordingly, such traditional advertising media as newspapers, radio and television, which require substantial lead times can be needed to allow for the preparation and dissemination of advertising messages, are often not the most effective means for informing consumers of the existence and terms of the special.

One alternative to such conventional advertising media as newspapers, radio and television is the use of printed display banners for displaying visually perceived promotional material. Banners of this type are typically screen printed with high quality graphics. Such banners not only have the advantage of being relatively economical, but such products are also easy to erect and take down, and thus are capable of being located close to the particular items or goods being offered. Advertising banners known in the art are typically made from a thermoplastic such as polyethylene, polypropylene, or polyester. Generally, such banners include a variety of graphic information for offering products or services. To customize the banner for a particular sale, special or the like, such banners may have an area in which a user can provide custom information in addition to other graphic information printed on the banner. Such custom information is many times added to the banner by simply writing thereon, such as with a marker. Although providing custom information, such an approach results in an advertising media that does not appear professional and is inconsistent with other printed graphics on the banner. Other techniques to add custom information include the use of polyvinyl chlorine pouches, pinch type bags or stick-on letters adhesively adhered or taped to the banner on the front side thereof. Numbers or letters are inserted into the pouch or adhered directly to the banner in order to convey to an observer a price, special message or the like.

Although more attractive than written on information, the use of vinyl pouches, pinch bags, and stick-on letters and numbers also has various deficiencies, such as the failure of the adhesive bond between the pouch and the banner or stick-on graphics. Such bonds weaken in inclement weather and eventually may separate the two components. Furthermore, stick-on or taped pouches, pinch bags, lettering or numbering, often contain solvents or plasticizers as ingredients of the adhesive which attack the pockets and banners, causing puckering between the two adhered components. This separation allows dust or moisture an entry point to further work at breaking down the adhesive and ultimately can separate the components. Such approaches also result in a visually unappealing advertising media which can affect the marketability of the advertised product. Further, such approaches of the prior art require that a proprietor maintain an inventory of various sizes, shapes, and colors of letters, numbers or the like that are to be used on the advertising banners. This along with the time required to add such items to an advertising banner, result in a product which is cumbersome to use. Such approaches also require the proprietor to ensure that the letters and numbers are placed in a visually appealing manner for the appropriate product on the display banner, which is many times not accomplished.

Such advertising banners or the like are also used to promote specials offered by a manufacturer on a national or regional basis, wherein the product may include particular graphic or other information. In such situations, although the manufacturer desires that such advertising be consistent and uniform, the ability to customize the advertising for a particular location is also desired. The prior approaches do not necessarily result in an advertising product which is visually appealing, as the custom information is not of a similar character as other printed information thereon.

A variety of print methods have been employed for imaging various sheet materials. Commonly employed print methods include gravure, off-set, flexographic, lithographic, electrographic, electrophotographic (including laser printing and xerography), ion deposition (also referred to as electron beam imaging (EBI)), magnetographics, inkjet printing, screen printing, and thermal mass transfer. However, with the advent of low cost, high quality inkjet printers, there has been an increased interest in inkjet printing. Inkjet techniques have become vastly popular in commercial and consumer applications. The ability to use a personal computer and inkjet printer to print digital images provides high quality printed material in a simple and cost effective manner.

Photo or other images now can be digitally made and stored on magnetic media, optical disks, or computer memory. Inkjet printing allows the printing of photo realistic graphics quickly and economically. Because of simplicity of operation, the low cost of inkjet printers, and improvements in ink technology, the inkjet imaging process provides a printing process which has many advantages. To get the continuous tone appearance required for photo realistic graphics, some inkjet printer manufacturers have offered printers that have higher resolution, smaller drop volumes, and additional colors. Now, a typical desk top inkjet printer can have resolution to 1440 dpi. In addition, some inkjet printers jet more than the standard cyan, yellow, magenta, and black (CYMK) colors. Additional colors such as light cyan and light magenta have been added to increase the effective resolution. These types of improvements to inkjet printers have lowered the total amount of required ink used and closed the image quality gap when compared with other known printing technology. Inkjet inks have been formulated as both dye-based and pigment-based inks.

It therefore would be desirable to have a mass customizable display banner which allows the user to provide custom information in a simple and visually appealing manner, with the custom information matching the quality of other graphics which may be printed thereon. It would also be desirable to provide advertising media which allows customization without the requirement of vinyl pouches, pinch bags, stick-on letters and numbers or the like is adapted to effectively and accurately inform consumers of products or services in a visually appealing manner through the use displaying an image on an ink receptive layer that is selectively provided on a predetermined area of a printed display banner.

### SUMMARY OF THE INVENTION

A product having an image receptive portion thereon is disclosed, along with a method of producing such a product. The product, in accordance with the present invention comprises a substrate having a first and a second surface, a non-porous image layer printed on at least a portion the first surface of the substrate, and an ink receptive layer selectively applied on a predetermined area of the non-porous image layer and a portion of the first surface of the substrate, wherein the ink receptive layer is preferably receptive to an inkjet ink. In an embodiment, a plurality of aqueous absorbable granules and an aqueous UV curable coating provide the ink receptive layer.

The product in accordance with the present invention may be utilized in conjunction with printed advertising media including banners, displays, poster, signs, and the like. In an embodiment, the image receptive material is adapted to receive an image comprised of aqueous ink. In a particular embodiment, the image receptive material is adapted to receive an image comprised of aqueous pigmented ink adapted for use in an inkjet printer. A printed image in accordance with the present invention may include one or more text-based and/or numerical indicia. Examples of text-based indicia that may be suitable in some applications include the name of the establishment where the advertising media is located and the description of the products or services being advertised. Examples of the numerical indicia that may be suitable in some applications include the cost and quantity of products being advertised.

In an embodiment, the present invention provides a display advertising system for displaying a visual advertising message formed of a first printed fixed visual component and at least one customizable printed component. The system comprises a substrate having a first and a second surface, with the first surface having the fixed visual component of the advertising message on a portion of the first surface; and an ink receptive layer selectively positioned on a predetermined area of the fixed visual component and a portion of the first surface of the substrate. The ink receptive layer is receptive to an inkjet ink.

In another embodiment, the present invention provides an advertising media comprising a thermoplastic substrate having a first and a second surface; an ink layer, wherein the layer includes an ink selected from the group consisting of a solvent, aqueous, and UV-curable based ink, printed on a portion of the first surface of the substrate, wherein the ink layer forms a non-porous image layer. An inkjet receptive layer is selectively applied on a predetermined area of the non-porous image layer and a portion of the first surface of the substrate, wherein the inkjet ink receptive layer can thereafter be printed with custom information.

In another embodiment, the present invention provides a method of providing an image receptive medium on a portion of a product, comprising the steps of providing a substrate having a first and a second surface; printing a non-porous image layer on a portion of the first surface of the substrate; and applying an ink receptive layer on a predetermined area of the non-porous image layer and a portion of the first surface of the substrate, wherein the ink receptive layer is receptive to an inkjet ink.

The present invention also provides a method of facilitating a business relationship between a first party and a second party comprising the steps of preparing an advertising product by the first party, such as a national advertiser, wherein the product comprises a substrate having a first and a second surface. A non-porous image layer is printed on a portion of the first surface of the substrate, and an ink receptive layer is selectively applied on a predetermined area of the non-porous image layer and a portion of the first surface of the substrate. The ink receptive layer may be receptive to an inkjet ink. The advertising product is provided to the second party, wherein the second party is a local distributor for example. The second party prints a customized image onto the ink receptive layer for advertising purposes. The second party may itself utilize the product or may distribute the customized product to local proprietors.

### BRIEF DESCRIPTION OF THE DRAWINGS

FIG 1A. is a diagrammatic, cross-sectional view of a product in accordance with an embodiment of the present invention.

FIG 1B. is a diagrammatic, cross-sectional view of a product in accordance with another embodiment of the present invention.

FIG. 2 is a diagrammatic representation of the manufacturing process to produce the product in accordance with an embodiment of the present invention.

FIG. 3A is a front elevational view of the advertising product in accordance with the embodiment of the present invention.

FIG. 3B is a front elevational view of the advertising product in accordance with another embodiment of the present invention.

### DETAILED DESCRIPTION OF THE PREFERRED EMBODIMENTS

The image receptive medium of the present invention will be explained in more detail hereinafter.

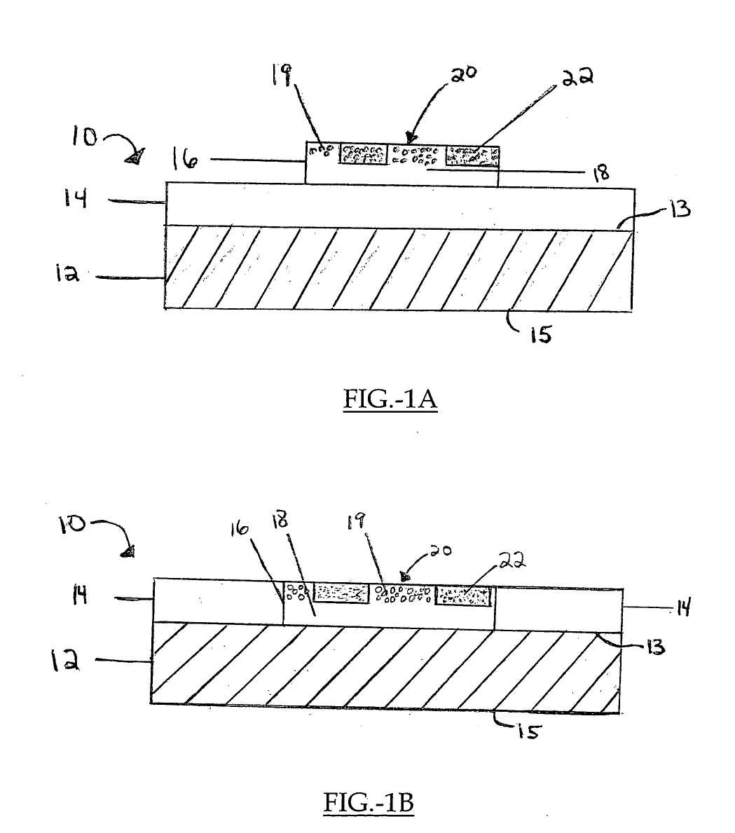

FIG. 1A is a diagrammatic cross-sectional view of a product 10 in accordance with the present invention. Product 10 includes a substrate 12, a non-porous image layer 14, and an ink receptive layer 16, disposed on one side 13 of substrate 12. As seen in FIG. 1A, non-porous image layer 14 is disposed completely on side 13 of substrate 12 and ink receptive layer 16 is selectively applied to at least one predetermined area of non-porous image layer 14. As seen in FIG. 1B, the ink receptive layer may be provided over only a portion of side 13, at a predetermined location thereon, where non-porous image layer 14 is not printed on side 13 of substrate 12. The non-porous image layer 14, and ink receptive layer 16 can also simultaneously be placed on the opposite side 15 of substrate 12 if desired. In the embodiment of FIGS. 1A and 1B, an ink retention system 16 comprises an inkjet ink receptive coating 18 defining a plurality of pores (not shown) and a plurality of granules 19 which are disposed within the ink receptive coating 18. In a preferred embodiment for use with dye based inks, the ink receptive coating 18 renders the ink receptive layer 16 hydrophilic.

The non-porous image layer 14 may be formed by any suitable printing technique, such as screen printing or other known processes. A printed image 20 comprising an ink 22 is disposed on/in ink receptive layer 16. In a preferred embodiment, ink 22 comprises an aqueous ink. In a particularly preferred embodiment, ink 22 comprises an aqueous ink adapted for use in an inkjet printer. The product 10 may be utilized in conjunction with an inkjet printer to produce printed advertising media including banners, displays, poster, signs, and the like. The printed advertising media can be used for on-premise establishments that include bars, restaurants, and diners where the advertised product in consumed in-house. The printed advertising media can also be used for off-premise establishments that include grocery stores, convenient stores, and drive-thru beverage stores where the advertised product is purchased onsite, but consumed offsite. Printed image 20 may include one or more text-based and/or numerical indicia. Examples of text-based indicia that may be suitable in some applications include the name of the establishment where the advertising media is located, a description of the products or services being advertised or the like. Examples of the numerical indicia that may be suitable in some applications include the cost and the quantity of material being advertised.

Substrate

Substrate 12 may comprise a number of commercially available materials. In a presently preferred embodiment, substrate 12 is planar and comprises a thermoplastic material. Substrate 12 may comprise many thermoplastic and non-thermoplastic materials without deviating from the spirit and scope of the present invention. Examples of thermoplastic materials that may be suitable in some applications include polyethylene (PE), polypropylene (PP), polyvinylchloride (PVC), polyvinyl chloride-co-vinyl acetate (PVC/VA,) polyethylene terephthalate (PET), polyethylene terephthalate glycol (PETG), terephthalic acid ethylene glycol cyclohexanone dimethonal copolymer, acrylic, polyimide, polyamide, and thermoplastic polyurethane. Examples of non-thermoplastic material that may be suitable in some applications include paper and paper-related materials.

It is generally preferred that the material from which the substrate is formed be compatible for printing of the non-porous image layer 14 as well as providing the ink receptive medium over a portion thereof. These materials are capable of binding to the substrate 12.

Referring to FIG. 1, different embodiments of structure 10 are possible. For example a tie layer can be disposed between the non-porous image layer 14 and ink receptive layer 16. The tie layer may comprise various materials without deviating from the spirit and scope of the present invention. Examples of tie materials which may be suitable in some applications include polyvinyl chloride (PVC)/vinyl acetate copolymers, acid/acrylate modified ethylene vinyl acetate (EVA), and acid/anhydride-modified polyethylene. Acid/acrylate modified ethylene vinyl acetate is commercially available from E. I. du Pont de Nemours and Company of Wilmington, Del. which identifies this material with the trade name BYNEL. Acid/anhydride-modified polyethylene is commercially available from Equistar Chemicals LP of Houston, Tex. that identifies this material with the trade name PLAXAR. Blends of the Acid/acrylate modified ethylene vinyl acetate and BYNEL resins are useful for attaching PVC/VA non-porous system 14 to substrates 12 made of polypropylene, polyethylene, or their copolymer blends.

Non-Porous Image Layer

Depending on the effect desired, the non-porous image layer 14 comprises graphic information, has desirable patterns, designs, or other permanent indicia that are printed directly onto the surface of the substrate 12. Printing of image layer 14 may be performed by various methods of printing known in the art such as by gravure, flexography, screen-printing, jet printing, web printing, lithography, off-set printing, and the like. The preferred printing method is screen-printing due to the high quality yet low cost of such printing. The non-porous image layer 14 may be formed from solvent-based, aqueous, UV curable, and other printing inks that are known to one who is skilled in the art.

Ink Receptive Layer

The ink receptive layer 16 comprises an ink receptive coating 18, preferably for inkjet ink, that is preferably a hydrophilic resin. Resins generally used for an ink-receiving layer of the conventional ink jet printing materials can be used. These resins include synthetic resins such as polyvinyl alcohols, polyvinyl pyrrolidones, water soluble cellulose resins, water soluble polyester resins, polyvinyl acetal, acrylic acid-acrylic amide copolymer, melamine resins, polyetherpolyol resins and cross-linked compounds thereof and the like, natural resins such as gelatin, casein, starch, chitin, chitosan and the like.

In another embodiment, the ink receptive layer 16 contains an ink receptive coating 18 that is receptive to solvent-based, non-aqueous inks. A solvent-based ink receptive coating 18 may have a carrier portion that is generally olefin-based. Generally, copolymers comprising the reaction product of olefin monomers and a sufficient amount of at least one polar monomer (modified olefin resins) provide the desired coating. Specific examples of useful copolymers include copolymers of ethylene and vinyl acetate, carbon monoxide, and methyl acrylate; copolymers of acid and/or acrylate modified ethylene and vinyl acetate, and terpolymers of ethylene and any two polar monomers, for example, vinyl acetate and carbon monoxide. Other useful ink receptive coatings include urethanes and polyesters such as thermoplastic polyurethanes and polyether-ester elastomers, and other commercially available modified olefin resins.

The other portion of the ink receptive coating 18 may be ink absorptive additive resins, such as polymethacrylic resins, vinyl resins, polystyrene resins or other suitable materials. Specific examples of useful methacrylic resins include copolymers of methyl methacrylate with butyl acrylate, butyl methacrylate, isobutyl methacrylate, or isobomyl methacrylate, copolymers of isobutylmethacrylate and butyl methacrylate, and isobutyl methacrylate resins. The incorporation of butyl acrylate, butyl methacrylate, isobutyl methacrylate, or isobomyl methacrylate comonomer into methyl methacrylate resins reduces the solubility parameter of the resulting methacrylic resin such that the solubility parameter of the resin more closely matches that of the solvent system in the inks, thereby providing faster solvent absorption for the print receptive blend. The incorporation of these comonomers into methacrylic resin also typically reduces the glass transition temperature of the methacrylic resin which may also facilitate solvent uptake by the image receptive layer. Combinations of such resins may also be used as the ink absorptive resin.

In a preferred embodiment of the present invention, a UV curable coating is used with an aqueous inkjet ink. However, in order to use this type of UV curable coating with the present invention, the coating must be modified in such a way to make it a water-based so that it can absorb the aqueous inkjet ink. In the present invention, granules 19 are preferably found as close to the surface of the in the ink receptive layer as possible in order to facilitate the absorption of the inkjet printer ink 22. Examples of materials which may be suitable in some applications include calcium carbonate, fumed silica, precipitated silica alumina, alkyl quaternary ammonium bentonite, alkyl quaternary ammonium montmorillonite, clay, kaolin, talcum, titanium oxide, chalk, bentonite, aluminum silicate calcium silicate, magnesium carbonate, calcium sulfate, barium sulfate, silicium oxide barium carbonate, boehmite, pseudo boehmite, aluminum oxide, aluminum hydroxide diatomaceous earth, calcined clay, and the like. If too much of the Uv curable resin is used, no inter particle porosity would be obtained. If not enough UV curable resin is used, the particles could fluff off like powder from the printing surface. Additional particles may serve various functions including ink retention. Examples of particle functions include pigmentation filling, lubricating, ultraviolet light absorption, whitening, heat stabilizing, and the like. The ink receptive layer 16 may further contain optional additives such as anti-foam agents, leveling agents, UV absorbers, light stabilizers, pigments and the like.

A method in accordance with the present invention preferably includes the steps of providing a substrate 12 and printing the non-porous image layer 14 thereon. The ink receptive layer 16 is then coated over a portion of the substrate. Various methods of dispersing the ink receptive layer across the substrate may be utilized without deviating from the spirit and scope of the present invention. For example, an inkjet receptive coating may be dispersed over a portion of the substrate by known methods that include the use of a Mayer rod, an air knife, notch bar coater, a doctor blade or the like. Alternatively, the ink receptive layer 16 of the present invention may be applied via a printing process. These printing processes include gravure, flexography, screen-printing, jet printing, web printing, lithography, off-set printing, and the like. The coating 16 may therefore be formed with a rheology which allows it to be applied via such a printing process. Further, enabling application of layer 16 with conventional printing processes may allow printing of both non-porous image layer 14 along with layer 16 in a single manufacturing pass.

If a non-UV curable coating is used as the ink receptive coating, the drying process may be enhanced by feeding the substrate through an oven or dryer after the ink receptive layer is dispersed. The oven temperature profile may be selected to allow for a desired surface structure to develop. Altering the solvents of the system can also enhance the speed of the solvent evaporating process. Thus, the effective line speed of the drying process and resulting surface structure formation can be controlled with faster evaporating solvents and slower evaporating non-solvents. The temperature in the first zone in the drying oven may be set at ambient temperature with mild air impingement to allow the primary gel of the porous layer to develop properly. Further oven zones can have increased temperatures and air impingement.

Printed Image

In a preferred embodiment, ink receptive layer 16 is capable of easily receiving a printed image comprising aqueous ink because of ink receptive coating 18. In a preferred method, the image 20 is printed onto ink retention system 16 utilizing an inkjet printing process. Other printing processes may be utilized without deviating from the spirit and scope of the present invention. Examples of printing processes, which may be suitable in some applications, include gravure printing, offset printing, silk screen printing, and flexographic printing.

A printed image in accordance with the present invention preferably includes one or more advertising indicia that allows for pinpoint messaging. Examples of advertising indicia that may be suitable in some applications include a the name of the establishment, the name of the advertised product, the cost of the advertised product, the schedules of local sports teams, both amateur and professional, pictures of local entertainment and/or sports personalities, etc.

The formation of precise inkjet images is provided by a variety of commercially available printing techniques. Non-limiting examples include thermal inkjet printers such as DeskJet brand, PaintJet brand, Deskwriter brand, DesignJet brand, and other printers commercially available from Hewlett Packard Corporation of Palo Alto, Calif. Also included are piezo type inkjet printers such as those from Seiko-Epson, Raster Graphics and Xerox, along with spray jet printers and continuous inkjet printers. Any of these commercially available printing techniques introduce the ink in a jet spray of a specific image on the medium of the present invention.

Many types of inks may be utilized in conjunction with the present invention. Examples of inks that may be suitable in some applications include organic solvent-based inks, water-based inks, thermo inks, UV curable inks, phase change inks, and radiation polymerizable inks. Inks utilizing various colorants may be utilized in conjunction with the present invention. Examples of colorants, which may be suitable in some applications, include dye-based colorants and pigment-based colorants. Factors that include temperature, humidity, indoor usage, and outdoor usage will determine the choice of dye-based inks or pigment-based inks in accordance with the present invention.

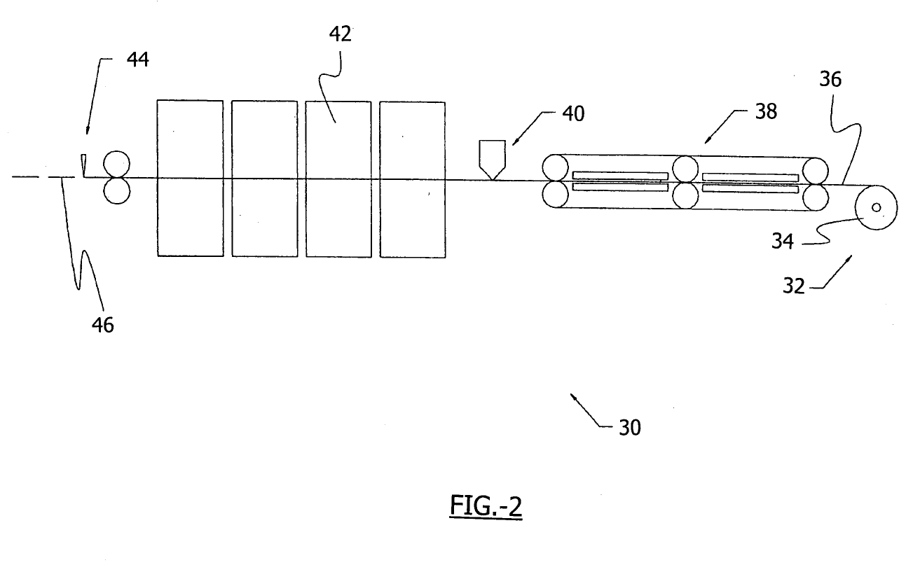

FIG. 2 is a diagrammatic representation of mass customization of a cast production line 30 in accordance with an exemplary embodiment of the present invention. In FIG. 2, a first unwind station 32 is illustrated. The first unwind station 32 includes a first roll 34 comprising a plurality of turns of a substrate web 36 and wherein at least one surface of the first roll 34 has a non-porous image layer 14 printed on it. As shown in FIG. 2, the substrate web 36 is unwound from the first roll 34 and passes through a roll set remover 38. After passing through the roll set remover 38, the substrate web 36 passes through a coating station 40. The coating station 40 applies the ink receptive layer 16 to a predetermined area of the non-porous image layer 14 to the substrate web 36. To facilitate drying when a non-UV curable coating is used in the ink receptive layer, the substrate web 36, including the layer of the ink receptive layer, is fed through a plurality of drying ovens 42. If an aqueous UV curable ink receptive coating is used, the drying ovens can be converted into UV/EB curing stations. After passing through the drying ovens or UV/EB curing stations, the substrate web enters a sheeting station 44 in which the web is cut into sheets 46. The non-porous image layer 14 may also be printed in an in-line process along with coating of ink receptive layer 16.

In another embodiment, the cast production line utilizes individual sheets wherein at least one side of the individual sheets has a non-porous image layer 14 printed on it. The individual sheets passes through a roll set remover 38. After passing through the roll set remover 38, the individual sheets pass through a coating station 40. The coating station 40 applies the ink receptive layer 16 to a predetermined area of the non-porous image layer 14 of each sheet. To facilitate drying when a non-UV curable coating is used in the ink receptive layer, the individual sheets are fed through a plurality of drying ovens 42. If an aqueous UV curable ink receptive coating is used, the drying ovens could be converted into UV/EB curing stations. After passing through the drying ovens or UV/EB curing stations, the individual sheets are packaged.

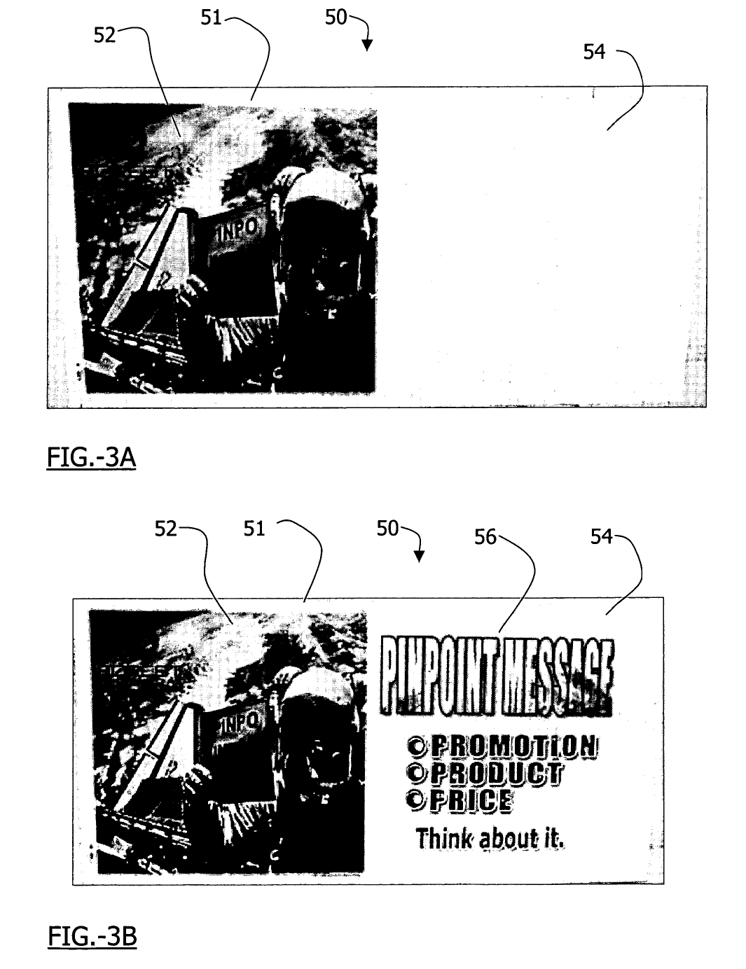

In another embodiment, the present invention also provides a method of facilitating a business relationship between-a first party and a second party. As seen in FIG. 3A, an advertising product 50 is prepared by a first party, such as a national advertiser, wherein the product 50 comprises a substrate 51 having a first and a second surface. A non-porous image layer 52 is printed on the first surface of the substrate. This non-porous image layer 52 can be any advertising logo or theme that the first party is promoting. Next, an ink receptive layer 54 is selectively applied on a predetermined area of the non-porous image layer. The ink receptive layer may be receptive to an inkjet ink. With this method, the first party can mass produce the advertising product having the same non-porous image layer 52 and ink receptive layer on each of the advertising products thereby increasing production efficiency and saving money. The advertising product is provided to the second party, wherein the second party is a local distributor for example. As seen in FIG. 3B, the second party prints a customized image 56 onto the ink receptive layer 54 for advertising purposes. The digital printing of the customized image 56 with an ink jet ink produces an image that is precise and neat, thereby rendering the image aesthetically pleasing. The use of an ink jet ink with digital printing also provides an image that can have depth, shading, multiple colors which adds to the aesthetic effect. The customized image 56 can include food and beverage specials and events including golf outings, clambakes, band appearances, karaoke, or any other promotional activity. The second party may itself utilize the product or may distribute the customized product to local proprietors.

While particular embodiments of the invention has been shown and described, it will be obvious to those skilled in the art that changes and modifications may be made without departing from the invention in its broader aspects and, therefore, the aim in the claims is to cover all such changes and modifications as fall within the scope of the invention.

1. An image receptive medium comprising a substrate having a first and a second surface;
a non-porous image layer printed on at least a portion of the first surface of the substrate; and
an ink receptive layer selectively applied on at least one predetermined area of the non-porous image layer and a portion of the first surface of the substrate, wherein the ink receptive layer is receptive to an inkjet ink.

2. The image receptive medium of claim 1, wherein the substrate is planar and comprises a thermoplastic or a paper material.

3. The image receptive medium of claim 2, wherein the thermoplastic material is selected from the group consisting of polyethylene, polypropylene, polyvinylchloride, and polyethylene terephthalate.

4. The image receptive medium of claim 1, wherein the non-porous image layer is printed on a portion of the first surface of the substrate by a printing process selected from the group consisting of a gravure process, an off-set process, a flexographic process, a lithographic process, an electrographic process, an electrophotographic process, an ion deposition process, a magnetographics process, an inkjet printing process, a screen printing process, and a thermal mass transfer process.

5. The image receptive medium of claim 4, wherein the non-porous image layer is printed on a portion of the first surface of the substrate by a screen printing process.

6. The image receptive medium of claim 1, wherein the non-porous image layer is a dried solvent-based printing ink.

7. The image receptive medium of claim 1, wherein the non-porous image layer is a cured ultra-violet curable printing ink.

8. The image receptive medium of claim 1, wherein the ink receptive layer is receptive to a solvent-based inkjet ink.

9. The image receptive medium of claim 1, wherein the ink receptive layer is receptive to an aqueous inkjet ink.

10. The image receptive medium of claim 1, wherein the ink receptive layer is a solvent-based coating.

11. The image receptive medium of claim 1, wherein the ink receptive layer is an ultra-violet curable coating.

12. The image receptive medium of claim 11, wherein the ultra-violet curable coating further comprises granules dispersed in the coating to facilitate the absorption of the inkjet ink.

13. The image receptive medium of claim 12, wherein the granules are preferably located substantially near the surface of the ultra-violet curable coating.

14. A display advertising system for displaying a visual advertising message formed of a first printed fixed visual component and at least one customizable printed component comprising:
a substrate having a first and a second surface and having thereon at least a portion of the first surface of the fixed visual component of the advertising message; and an ink receptive layer selectively positioned on a predetermined area of the fixed visual component and a portion of the first surface of the substrate, wherein the ink receptive layer is receptive to an inkjet ink.

15. The display advertising system of claim 14, wherein the substrate is planar and comprises a thermoplastic or a paper material.

16. The display advertising system of claim 15, wherein the thermoplastic material is selected from the group consisting of polyethylene, polypropylene, polyvinylchloride, and polyethylene terephthalate.

17. The display advertising system of claim 14, wherein the fixed visual component is printed on a portion of the first surface of the substrate by a printing process selected from the group consisting of a gravure process, an off-set process, a flexographic process, a lithographic process, an electrographic process, an electrophotographic process, an ion deposition process, a magnetographics process, an inkjet printing process, a screen printing process, and a thermal mass transfer process.

18. The display advertising system of claim 17, wherein the fixed visual component is printed on a portion of the first surface of the substrate by a screen printing process.

19. The display advertising system of claim 14, wherein the fixed visual component is a dried solvent-based printing ink.

20. The image receptive medium of claim 14, wherein the non-porous image layer is a cured ultra-violet curable printing ink.

21. The image receptive medium of claim 14, wherein the ink receptive layer is receptive to a solvent-based inkjet ink.

22. The image receptive medium of claim 14, wherein the ink receptive layer is receptive to an aqueous inkjet ink.

23. The display advertising system of claim 14, wherein the ink receptive layer is a solvent-based coating.

24. The display advertising system of claim 14, wherein the ink receptive layer is an ultra-violet curable coating.

25. The image receptive medium of claim 24, wherein the ultra-violet curable coating further comprises granules dispersed in the coating to facilitate the absorption of the inkjet ink.

26. The image receptive medium of claim 25, wherein the granules are preferably located substantially near the surface of the ultra-violet curable coating.

27. An advertising media comprising:
a thermoplastic substrate having a first and a second surface;
an ink layer, wherein the layer includes an ink selected from the group consisting of a solvent, aqueous, and UV-curable based ink, printed on a portion of the first surface of the substrate, wherein the ink layer forms a non-porous image layer; and
an inkjet receptive ink layer selectively applied on a predetermined area of the non-porous image layer and a portion of the first surface of the substrate, wherein the inkjet receptive layer is a composite selected from the group consisting of a solvent-based material, an aqueous-based material, and a UV-curable material, and wherein the inkjet receptive ink layer is receptive to an inkjet ink.

28. The advertising media of claim 27, wherein the thermoplastic substrate is selected from the group consisting of polyethylene, polypropylene, polyvinylchloride, and polyethylene terephthalate.

29. The advertising media of claim 27, wherein the non-porous image layer is printed on a portion of the first surface -of the substrate by a printing process selected from the group consisting of a gravure process, an off-set process, a flexographic process, a lithographic process, an electrographic process, an electrophotographic process, an ion deposition process, a magnetographics process, an inkjet printing process, a screen printing process, and a thermal mass transfer process.

30. The advertising media of claim 29, wherein the non-porous image layer is printed on a portion of the first surface of the substrate by a screen printing process.

31. The advertising media of claim 27, wherein the non-porous image layer is a dried solvent-based printing ink.

32. The advertising media of claim 27, wherein the non-porous image layer is a cured ultra-violet curable printing ink.

33. The advertising media of claim 27, wherein the ink receptive layer is receptive to a solvent-based inkjet ink.

34. The advertising media of claim 27, wherein the ink receptive layer is receptive to an aqueous inkjet ink.

35. The advertising media of claim 27, wherein the ink receptive layer is a solvent-based coating.

36. The advertising media of claim 27, wherein the ink receptive layer is an ultra-violet curable coating.

37. The advertising media of claim 36, wherein the ultra-violet curable coating further comprises granules dispersed in the coating to facilitate the absorption of the inkjet ink.

38. The advertising media of claim 37, wherein the granules are preferably located substantially near the surface of the ultra-violet curable coating.

39. A method of providing an image receptive medium comprising the steps of:
providing a substrate having a first and a second surface;
printing a non-porous image layer on a portion of the first surface of the substrate; and
applying an ink receptive layer on a predetermined area of the non-porous image layer and a portion of the first surface of the substrate, wherein the ink receptive layer is receptive to an inkjet ink.

40. The method of claim 39, wherein the substrate is planar and comprises a thermoplastic or a paper material.

41. The method of claim 40, wherein the thermoplastic material is selected from the group consisting of polyethylene, polypropylene, polyvinylchloride, and polyethylene terephthalate.

42. The method of claim 39, wherein the non-porous image layer is printed on a portion the first surface of the substrate by a printing process selected from the group consisting of a gravure process, an off-set process, a flexographic process, a lithographic process, an electrographic process, an electrophotographic process, an ion deposition process, a magnetographics process, an inkjet printing process, a screen printing process, and a thermal mass transfer process.

43. The method of claim 42, wherein the non-porous image layer is printed on the first surface of the substrate by a screen printing process.

44. The method of claim 39, wherein the non-porous image layer is a dried solvent-based printing ink.

45. The method of claim 39, wherein the non-porous image layer is a cured ultra-violet curable printing ink.

46. The method of claim 39, wherein the ink receptive layer is receptive to a solvent-based inkjet ink.

47. The method of claim 39, wherein the ink receptive layer is receptive to an aqueous inkjet ink.

48. The method of claim 39, wherein the ink receptive layer is a solvent-based coating.

49. The method of claim 39, wherein the ink receptive layer is an ultra-violet curable coating.

50. The image receptive medium of claim 49, wherein the ultra-violet curable coating further comprises granules dispersed in the coating to facilitate the absorption of the inkjet ink.

51. The image receptive medium of claim 50, wherein the granules are preferably located substantially near the surface of the ultra-violet curable coating.

52. A method of facilitating a business relationship between a first party and a second party comprising the steps of:
preparing an image receptive medium by the first party, wherein the first party is an advertiser, and wherein the medium comprises;
a substrate having a first and a second surface;
a non-porous image layer printed on a portion of the first surface of the substrate; and
an ink receptive layer selectively applied on a predetermined area of the non-porous image layer and a portion of the first surface of the substrate, wherein the ink receptive layer is receptive to an inkjet ink;
sending the image receptive medium to the second party, wherein the second party is a local distributor; and wherein the second party prints a customized and a detailed image onto the ink receptive layer for advertising purposes; and
having the second party distribute the customized image receptive medium to at least one local proprietor.
